(19) United States
(12) Patent Application Publication
(10) Pub. No.: US 2024/0296595 A1
(43) Pub. Date: Sep. 5, 2024

(54) METHOD AND SYSTEM OF GENERATING CUSTOMIZED IMAGES

(71) Applicant: Microsoft Technology Licensing, LLC, Redmond, WA (US)

(72) Inventors: Fatima Zohra DAHA, Livermore, CA (US); Ji LI, San Jose, CA (US); Dachuan ZHANG, Sunnyvale, CA (US); Houwen PENG, Beijing (CN); Zheng ZHANG, Beijing (CN); Ruizhe WANG, Hefei (CN); Han HU, Beijing (CN)

(73) Assignee: Microsoft Technology Licensing, LLC, Redmond, WA (US)

(21) Appl. No.: 18/176,668

(22) Filed: Mar. 1, 2023

(51) Int. Cl. G06T 11/00; G06F 40/40; H04L 9/32

(52) U.S. Cl. CPC G06T 11/00; G06F 40/40; H04L 9/3213

(57) ABSTRACT

A data processing system for requesting a customized image from an image-generating artificial intelligence engine may include a processor and a memory comprising instructions for execution by the processor. The instructions, when executed by the processor, cause the processor to: accept user input from a user, the user input comprising an image; tokenize the image to generate a set of tokens for use by the image-generating artificial intelligence engine; and submit the set of tokens to the image-generating artificial intelligence engine to support a request by the user for a customized image corresponding to the tokenized image.

### BACKGROUND

Utilizing artificial intelligence (AI) systems to generate original content has become increasingly popular. In particular, GPT or Generative Pre-Training Transformer technology is a neural network machine learning model that is trained using vast amounts of internet data. As a result, the GPT engine can receive a textual input and generate, in response, a much larger volume of relevant and sophisticated machine-generated text. For example, the input may be in the form of a question in natural language, and the output is a response to the question, also in natural language, that may appear to have been written by a knowledgeable person. This is just one example. GPT has shown that language can be used to instruct a large neural network to perform a variety of text generation tasks.

However, this technology is not limited only to text. Another AI engine, Image GPT, has shown that the same type of neural network can also be used to generate images as the output. For example, DALL-E is a transformer language model similar to GPT but trained to output images in response to an input. Such image generation methods have many applications, including but not limited to content creation, entertainment, and general consumption.

In practice, such machine learning models for image generation do have some limitations, for example, when a user wants to generate a specific, customized or personalized image. Thus, there is a need for improved systems and methods that provide a technical solution for generating imagery with elements that are more specific or customized for the user than are available with the vast training set underlying the machine learning model of an image-generating AI engine.

### SUMMARY

In one general aspect, the instant disclosure presents a data processing system having a processor and a memory comprising instructions for execution by the processor. The instructions, when executed by the processor, cause the processor to: accept user input from a user, the user input comprising an image; tokenize the image to generate a set of tokens for use by an image-generating artificial intelligence engine; and submit the set of tokens to the image-generating artificial intelligence engine to support a request by the user for a customized image corresponding to the tokenized image.

In another general aspect, the instant disclosure presents a method of generating a customized image with an image-generating artificial intelligence engine. The method includes generating a fine-tuning mechanism for the image-generating artificial intelligence engine, the fine-tuning mechanism comprising a set of tokens defining an appearance of a person or object to be included in the customized image and a Natural Language Processing (NLP) layer that associates terms for referring to the person or object with the set of tokens; and submitting the fine-tuning mechanism to the image-generating artificial intelligence engine.

In a third general aspect, the instant disclosure presents a data processing system having a server; an image-generating artificial intelligence engine on the server; and a memory comprising instructions for the image-generating artificial intelligence engine. The instructions, when executed by the engine, cause the engine to: receive a fine-tuning mechanism that comprises a set of tokens defining an appearance of a specific person or object and a Natural Language Processing (NLP) layer in which terminology that refers to the person or object is associated with the set of tokens; and generate a personalized image using the set of tokens and NLP layer, the personalized image including a depiction of the specific person or object tokenized in the fine-tuning mechanism.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A depicts an illustrative system in which aspects of this disclosure may be implemented.

FIG. 1B depicts a different application of the example system of FIG. 1A in which aspects of this disclosure may be implemented.

FIG. 1C depicts a third application of the example system of FIG. 1A in which aspects of this disclosure may be implemented.

FIG. 2 depicts further elements of an illustrative system, additional to those in FIGS. 1A-C, in which aspects of this disclosure may be implemented.

FIG. 3 depicts a specific application of the illustrative system from FIG. 2.

FIG. 4A is a flow diagram depicting an illustrative method at the client side for fine tuning an image generating artificial intelligence to produce customized or personalized images.

FIG. 4B is a flow diagram depicting an illustrative method at the server side for fine tuning an image generating artificial intelligence to produce customized or personalized images.

FIG. 5 is a block diagram illustrating an example software architecture, various portions of which may be used in conjunction with various hardware architectures herein described.

FIG. 6 is a block diagram illustrating components of an example machine configured to read instructions from a machine-readable medium and perform any of the features described herein.

### DETAILED DESCRIPTION

As noted above, Artificial Intelligence (AI) engines for image generation will receive an input that describes the image to be produced. From that description, the AI engine will generate a corresponding output image based on the input description. This process is sometimes referred to as a text-to-image transformation. For example, the user may input a request for an image of “a collection of glasses sitting on a table” and receive an image meeting this description as the output. The user may also request the style of the output image. For example, the input could specify that the output is to be a photograph, a pencil sketch or a cartoon. The AI will then format the image according to the specified style. Thus, the collection of glasses sitting on a table could appear as a photograph or a pencil sketch depending on the input request.

There are various existing examples of image-generating AI engines. Some are listed here:
GPT-3 Generated Images: This is an AI-powered image generation system that uses the GPT-3 language model.
PaintsChainer: This is a deep learning system that can automatically color line drawings.
DeepDream: This is an early example of using deep learning for image generation. It involves using a convolutional neural network to generate highly abstract and surreal images.
NVIDIA's Image Generative Adversarial Network (GAN): This is a research project aimed at using GANs to generate high-quality images.
   These are just a few examples of AI-powered image generation systems. Each one uses different techniques and approaches, but all of them aim to automate the process of generating images in some way.

The techniques described herein can be applied to any image-generating AI engine. However, one current example of an image-generating AI engine that can be used as the AI engine in the techniques described herein is DALL-E, as mentioned above. DALL-E is a transformer language model similar to GPT but trained to output images in response to user input. Specifically, DALL-E is a 12-billion parameter version of GPT-3 trained to generate images from text descriptions, using a dataset of text-image pairs. It has a diverse set of capabilities, including creating anthropomorphized versions of animals and objects, combining unrelated concepts in plausible ways, rendering text, and applying transformations to existing images.

DALL-E and other similar image generating AI engines process input by generating tokens. These tokens are created by encoding the textual description into a numerical representation, which is then fed into the model to generate an image. The tokens in DALL-E represent specific elements or attributes of the desired image, such as shape, color, and style. These elements are combined to form a coherent image that matches the description provided as input.

DALL-E's vocabulary has tokens for both text and image concepts. Specifically, each image caption is represented using a maximum of 256 Byte Pair Encoded tokens with a vocabulary size of 16384, and the image is represented using 1024 tokens with a vocabulary size of 8192. Thus, DALL-E is a transformer language model that receives both text and image as a single stream of data containing up to 1280 tokens.

DALL-E is trained using “maximum likelihood” to generate all of the tokens for an output image, one after another. Maximum likelihood is a commonly used method in machine learning for estimating the parameters of a probabilistic model. In the case of DALL-E, the model is trained to generate images by predicting the next token in a sequence of tokens that represents the textual description of the image.

During training, the model is shown a large dataset of textual descriptions and the corresponding images, and it learns to predict the next token in the sequence given the previous tokens. By repeatedly predicting the next token and updating the model's parameters based on the accuracy of its predictions, DALL-E becomes better at generating images that match the textual descriptions. In essence, DALL-E is trained to maximize the likelihood that the generated tokens match the ground-truth tokens in the training data, and thus generate images that are consistent with the textual descriptions. This training procedure allows DALL-E to not only generate an image from scratch, but also to regenerate any rectangular region of an existing image that extends to the bottom-right corner, in a way that is consistent with the text prompt.

Thus, image-generating AI engines, such as DALL-E, operate on learned associations between input text and image-defining tokens. Given a textual input, the engine will utilize the tokens associated with that text to generate the output image. This association between text and tokens is the product of the training of the AI engine model so as to enable the production of corresponding images.

However, as noted above, current machine learning models for image generation have some limitations when a user wants to generate a customized or personalized image. For example, if a user wants to include an image of herself or himself as an element of the AI-generated image, current AI models may not recognize that the request is for inclusion of an image of the specific requesting user as an element of the output image. Similarly, if a user wants to include a specific object, such as a pet, a logo or company's product, as an element of the output image, the general training of the AI will not adapt to this level of specific output.

This is, at least in part, because the AI engine does not have a specific association between the text specifying the particular item to be included, such as the user's image, and corresponding tokens. For example, an input such as “a pencil drawing of me” may be misinterpreted by the AI engine because the textual input “me” is not associated with tokens for my personal appearance in image form.

Consequently, the present specification will describe a technical solution to enable an image-generation AI engine to utilize its vast and generalized training set while also adapting to customized or personalized elements that a user wants to include in the output image. While this could be done by retraining some or all of the AI engine so as to include tokens corresponding textual input such as “me” or “I” with the specific user's image or the like, this approach would not be feasible for every instance in which a user may want specific customized elements in an output image. Retraining an entire AI engine for even one customized instance would be extremely time-consuming and expensive. Hence, there is a need for improved systems and methods that provide a technical solution for generating imagery with elements that are more customized or personalized for the user than are available with the vast training set typically underlying an image-generating AI engine.

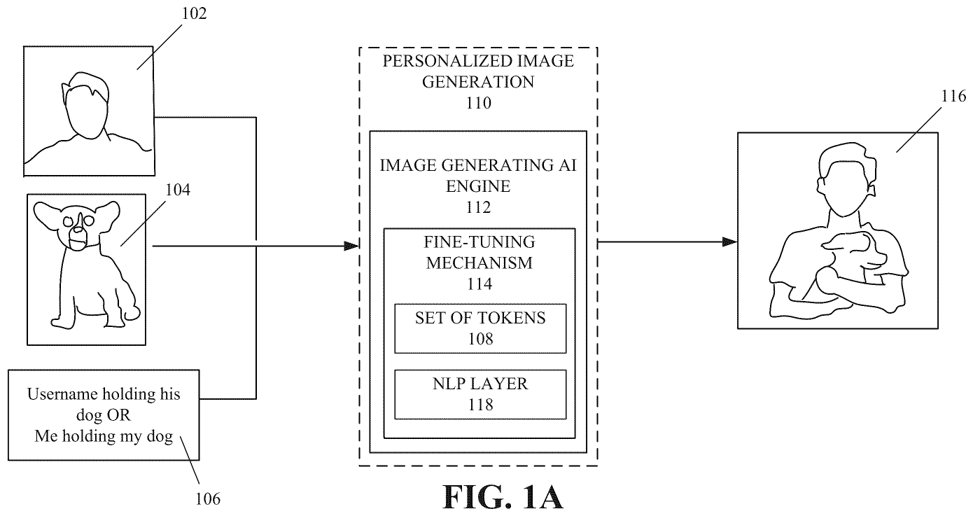

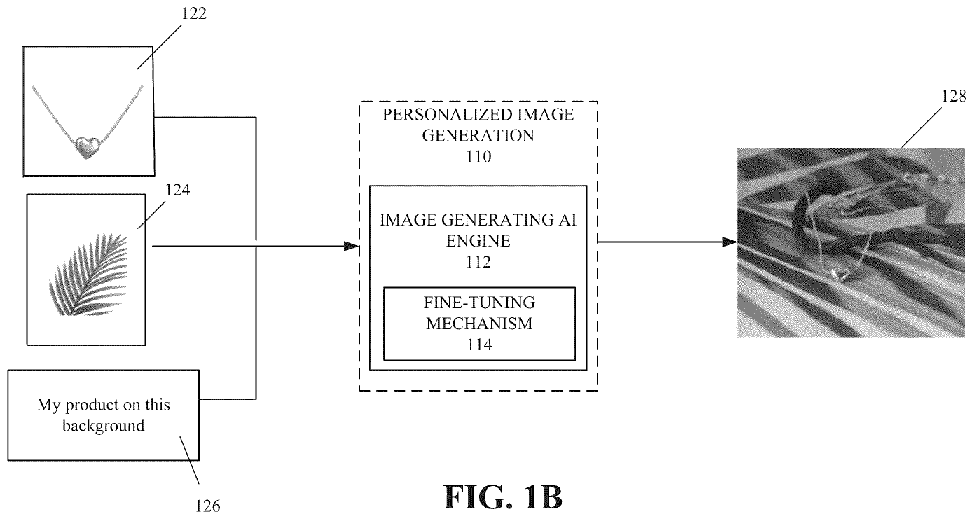

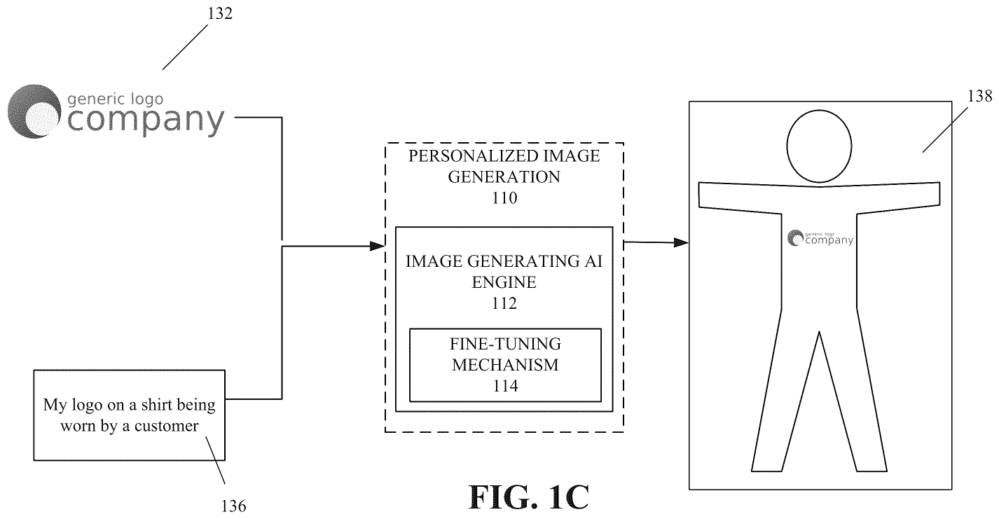

FIG. 1A depicts an illustrative system in which aspects of this disclosure may be implemented. FIG. 1A also depicts a specific illustrative application of the disclosed technique. In FIG. 1A, the user wants to generate an image of himself holding his dog. Typically, an image generating AI would readily be able to respond to the command of “a person holding a dog.” From such a prompt, the AI will produce any number of possible images of a person holding a dog. However, the appearance of the person and the dog will vary from iteration to iteration, and none will likely be the specific requesting user or his dog.

Wanting the customized image described, the user may input the textual prompt 106 of “Username holding his dog” or “Me holding my dog.” Without the technical solution described herein, however, the image generating AI engine 112 will be unable to correctly interpret “Username,” “his dog,” “me” or “my dog.” With the general training of the typical AI engine, these terms have no connection to the specific appearance of the user or his dog.

Consequently, within a client application that will be described in further detail below, the user will create a fine-tuning mechanism 114 that is input along with the user's request to the image-generating AI engine 112. This fine-tuning mechanism 114 will include additional tokens that have been generated from images of the specific personalized elements that the user wants to having included in the image generated by the image-generating AI engine 112.

In this example, the fine-tuning mechanism 114 will include a set of tokens 108 that define the appearance of the user based on a number of images of the user 102. The more images of the user that are used in forming this set of personalized tokens, the more accurately the set of tokens 108 will represent the appearance of the user when used by the image-generating AI engine 112. In this example, the fine-tuning mechanism 114 will also include a set of tokens generated from a number of images of the user's dog 104.

In addition to the set of tokens 108, the fine-tuning mechanism may also include an additional Natural Language Processing (NLP) layer 118 to be added to the NLP system of the image-generating AI engine 112. The additional NLP layer 118 associates the relevant wording of the textual input to the corresponding tokens in the fine-tuning mechanism. For example, the additional NLP layer 118 will associate the user's name (in any of a variety of forms) and words such as “I,” “me,” and “my” with the identity of the user and the set of tokens 108 derived that define the user's appearance based on images of the user. The NLP layer 118 will also associate a phrase such as “my dog” with tokens from the set 108 that define the appearance of the specific dog that belongs to the user.

Consequently, in this example, the user will provide as input to a personalized image generation system 110, an image or images 102 of the user and an image or images 104 of the user's dog. The user will also give a textual description 106 of the image to be generated, i.e., “Username holding his dog” or “Me holding my dog.” The images 102 and 104 will be tokenized according to the process for generating tokens used by whatever image generating AI engine 112 is implemented in the system. This could be any of the AI engines listed above or AI engines subsequently developed to generate images.

This set of tokens 108 and the corresponding NLP layer 118 will be packaged as a fine-tuning mechanism 114. This fine-tuning mechanism 114 may be configured as a plug-in or add-in to the image generating AI engine 112 and input via an Application Programming Interface (API) of the image generating AI engine 112.

The fine-tuning mechanism 114 is thus transmitted to the image generating AI engine 112 and implemented, as described above. The command 106 is then executed by the image generating AI engine 112. In executing the command, the image generating AI engine 112 can use the tokens 108 and NLP layer 118 of the fine-tuning mechanism to personalize or customize the output image 116 without comprising the ability learned from its underlying training set that informs how an image should appear based on the command, e.g., how a person looks holding a dog.

FIG. 1B depicts a different application of the example system of FIG. 1A in which aspects of this disclosure may be implemented. In the scenario illustrated in FIG. 1B, the user is accessing the personalized image generation system 110 and image generating AI engine 112 to prepare advertising for a particular product. In this example, the input from the user includes one or more images 122 of the product and one or more images 124 for a background or other elements with which the product is to be depicted.

Similar to the previous example, a fine-tuning mechanism 114 is generated that include a set of tokens for the image(s) 122 of the product and image(s) 124 of the background. Additionally, an NLP layer is generated that associates the relevant terms with the corresponding tokens. For example, the term “my product” or “the product” will be associated with the set of tokens prepared from the image(s) 122 that define the appearance of the product. The term “background,” “this background” or similar will be associated with the set of tokens prepared from the image(s) 124 of the background or other elements to be depicted with the product.

The fine-tuning mechanism 114 is then transmitted to the image generating AI engine 112 and implemented, as described above, along with the command 126. In this example, the command is to produce an image of “my product on this background.” The command 126 is then executed by the image generating AI engine 112. In executing the command, the image generating AI engine 112 can use the tokens and NLP layer of the fine-tuning mechanism to personalize or customize the output image 128 without comprising the ability learned from its underlying training set that informs how an image should appear based on the command. The resulting image 128 accurately depicts the user's product with the specified background.

FIG. 1C depicts a third application of the example system of FIG. 1A in which aspects of this disclosure may be implemented. In this scenario, the user wants an image of “my logo on a shirt being worn by a customer.” Thus, this command 136 along with an image or images of the user's logo 132 are input to the personalized image generation system 110. As before, the appearance of the logo 132 is tokenized and the set of tokens is packaged in the fine-tuning mechanism 114. Similarly, an NLP layer is included with the fine-tuning mechanism to associate terms such as “my logo” with the tokens defining the appearance of the user's logo as opposed to all other logos that might be represented in the training set of the AI engine 112.

The fine-tuning mechanism 114 is then transmitted to the image generating AI engine 112 and implemented, as described above, along with the command 136. The command 136 is then executed by the image generating AI engine 112. In executing the command, the image generating AI engine 112 can use the tokens and NLP layer of the fine-tuning mechanism to personalize or customize the output image 138. The resulting image 138 can thus accurately depict the user's logo on a shirt being worn by a customer.

The user could also have used this process to customize the appearance of the customer to that of a specific person. Otherwise, the AI engine 112 will generate the appearance of some person as the customer according to its general training set.

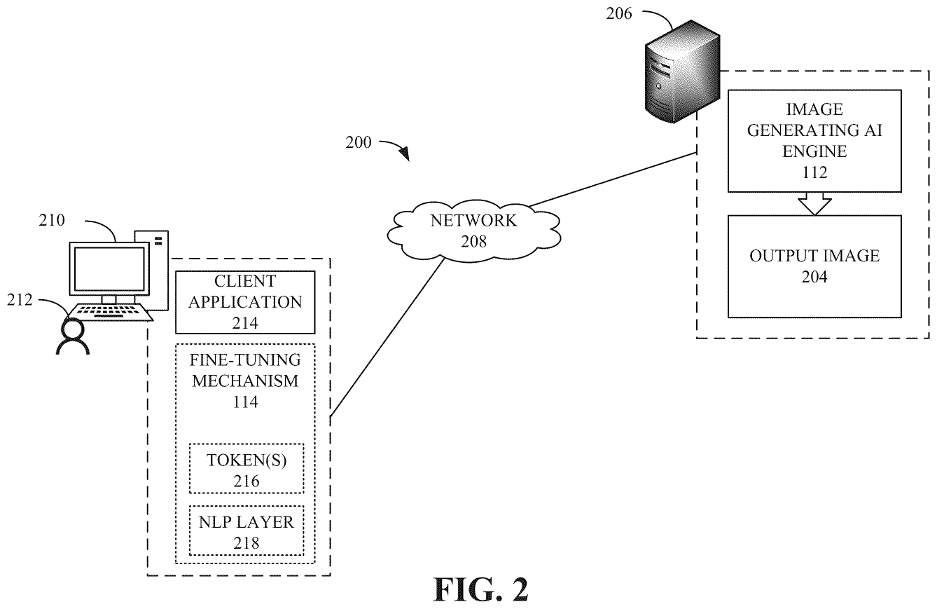

FIG. 2 depicts further elements of an illustrative system 200 that are additional to those in FIGS. 1A-C, in which aspects of this disclosure may be implemented. As shown in FIG. 2, the user 212 may be operating a client device 210 when performing any of the scenarios described above and others.

The user device 210 will have a client application 214 with a user interface for receiving user input and commands. The client application 214 may be a purpose-specific application for generating customized images using the image generating AI engine 112. In such an implementation, the client application 214 will include the programming to receive input images, such as those described above, that depict elements to be included in the personalized or customized image the user is seeking.

The client application 214 will also include the programming to tokenize those images to produce the set of tokens 216 that define the appearance of the elements in the input images that are to be included in the output image. The client application 214 will also include the programming to produce the additional NLP layer 218 that associates terms in the user's command with the corresponding tokens that define the appearance of a named element to be included in the output image. The client application 214 then generates the fine-tuning mechanism 114 that includes the set of tokens 216 and NLP layer 218.

As described above, the fine-tuning mechanism 114 is the submitted, via a computer network 208, to the image generating AI engine 112. The image generating AI engine 112 then implements the fine-tuning mechanism 114 and corresponding user command to produce a customized or personalized output image 204. This personalized output image 204 will include the specific person, object or other element that the user has specified rather than a generalized or non-specific equivalent.

The image generating AI engine 112 may be implemented on a server 206. In this way, the image generating AI engine 112 provides a service via the network 208. The network provides the medium over which the user transmits the fine-tuning mechanism 114 and receives, in return, the output image 204.

In a different example, the client application 214 could be a browser. In this implementation, the browser may provide the interface for receiving the input images and corresponding user command. The browser may then access a service for generating the fine-tuning mechanism 114. This service could be running on the server 206 that is also hosting the image generating AI engine 112 or could be resident at a different node of the network 208. Alternatively, the browser could download and implement a plug-in or add-in that provides the service of generating the fine-tuning mechanism as described herein. As used herein the term “server” may refer to any number of computing devices that support a particular service via the network.

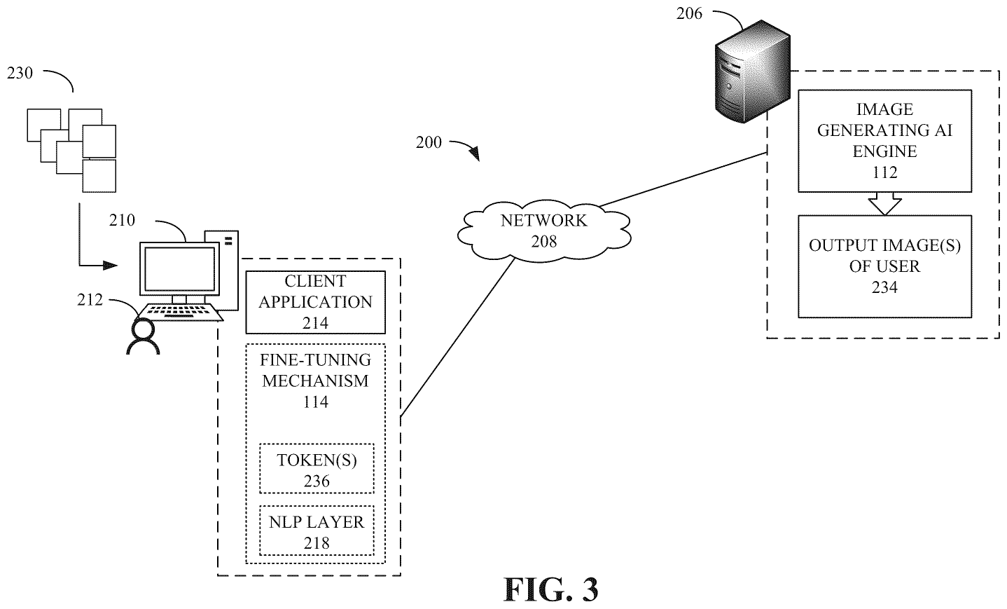

FIG. 3 depicts a specific application of the illustrative system from FIG. 2. In this scenario, the user 212 who is operating the user device 210 inputs a set 230 of multiple images of the user 212. The client application 214 receives the set 230 of images and generates a set of tokens that define the appearance of the user 212. As indicated, the larger the number of images 230, the more accurately the set of tokens 236 can define the user's appearance. The client application 214 will also generate an NLP layer 218 that associates terms referring to the user with the set of tokens 236 that define the appearance of the user. This NLP layer 218 may be pre-defined for this specific application with associations to wording and terms with which a person would normally refer to himself or herself.

In some examples, this may be an automated service in which the client application 214 automatically accesses an image repository for the images 230 of the user. This repository could be the user's phone, camera or online photo service where images are stored. The client application 214 accesses the image repository and generates the fine-tuning mechanism 114 without the user 212 needing to specifically guide the process.

As before, the fine-tuning mechanism 114 is then submitted to the image generating AI engine 112. The user can then describe different locations, actions, attitudes and other parameters in which he or she is to be depicted in the output image(s) 234 of the image generating AI engine 112. The user can also specific different styles of output image 234 such as a pencil sketch, cartoon art, anime portrait, watercolor art, concept art, sticker illustration, synthwave, hyper realistic and others. The image generating AI engine 112 will then generate the image or images 234 of the user in the specified style.

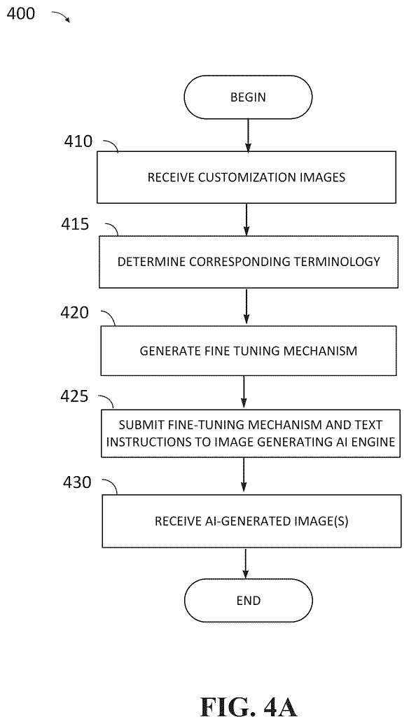

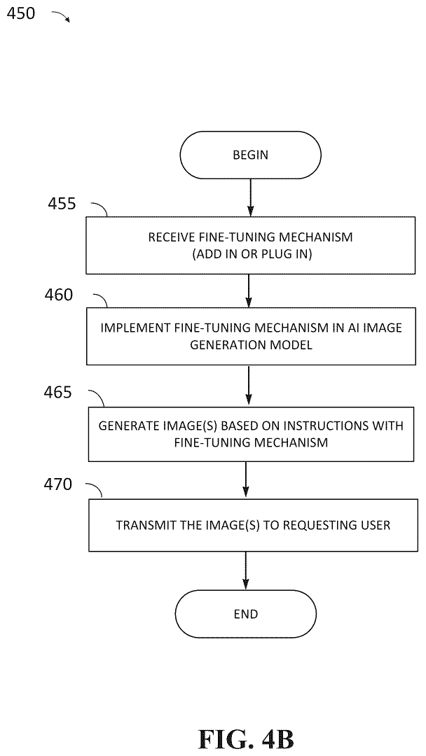

FIG. 4A is a flow diagram depicting an illustrative method at the client side for fine tuning an image generating artificial intelligence to produce customized or personalized images. Specifically, FIG. 4A illustrates the operation of the client application described above. As shown in FIG. 4A, the method 400 begins with receiving the customization image(s) 410. The customization image(s) can be depictions of any element that the user wants to include in a personalized or customized image. As described above, this could be the user's own image or an object from the user's life such as a pet, a product the user uses or sells, a logo with which the user is associated or anything else particular to the user.

The client application will then determine the corresponding terminology 415 that might be used to refer to any of the objects or elements depicted in the customization image(s). In various examples, this includes the terminology with which a user refers to himself or herself or any depicted object specific to the user, such as with possessive terminology such as “my” or “mine.”

The client application will then generate 420 the fine-tuning mechanism. As described above, this will include tokenizing the customization image or images according to the protocols of the image generating AI engine to be used. This will further include generating the additional NLP layer for the NLP system already in place in the image generating AI engine to be used.

The client application will then submit 425 the fine-tuning mechanism along with the text instructions describing the customized image to be generated. As above, the fine-tuning mechanism is submitted to an image generating AI engine. Specifically, the client application may utilize an API of the image generating AI engine to submit the fine-tuning mechanism. The fine-tuning mechanism may be in the form of a plug-in or add-in to the image generating AI engine 112. Finally, the client application will receive 430 the resulting AI-generated image(s) customized for the user by the image generating AI engine using the fine-tuning mechanism.

FIG. 4B is a flow diagram depicting an illustrative method 450 at the server side for fine tuning an image generating artificial intelligence to produce customized or personalized images. FIG. 4B illustrated a possible operation of the image generating AI engine. As shown in FIG. 4B, an illustrative image generating AI engine will receive 455 the fine-tuning mechanism generated by the user. This may be in the form of an add-in or plug-in.

The image generating AI engine will then implement 460 the fine-tuning mechanism to supplement its already-trained model. In this way, the image generating AI engine can utilize its underlying training set, that defines how things should appear in output images, with the tokens and NLP layer of the fine-tuning mechanism to include specific elements identified by the user in the output images. Thus, the output image or images are customized or specific to the user rather than being a generalized interpretation of the user's instruction for the output image(s).

The image generating AI engine will then generate 465 an image or images based on the user's instructions that have accompanied the fine-tuning mechanism. The resulting customized images are then transmitted 470 back to the requesting user.

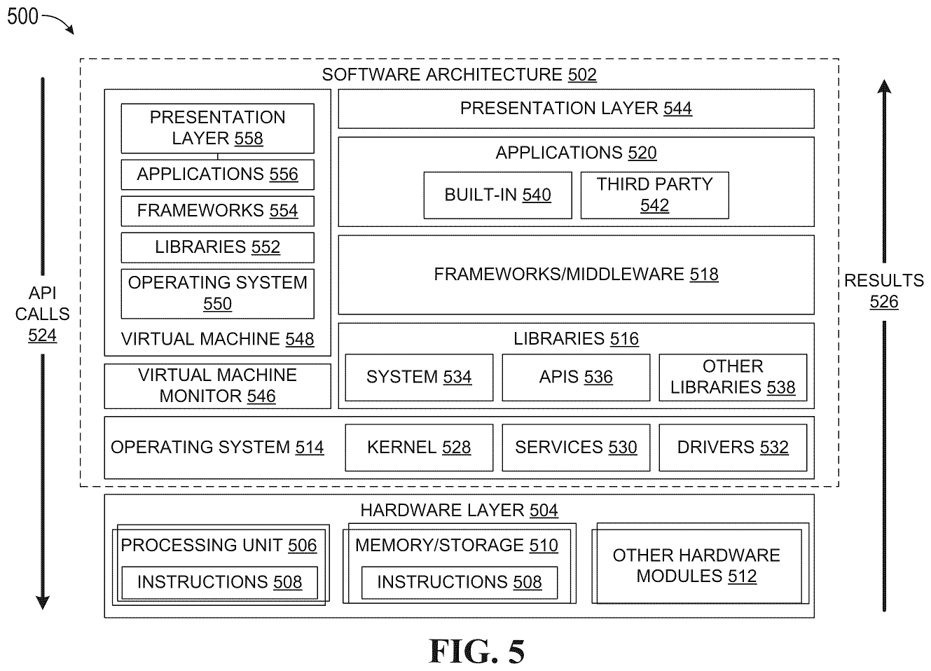

FIG. 5 is a block diagram 500 illustrating an example software architecture 502, various portions of which may be used in conjunction with various hardware architectures herein described, which may implement any of the above-described features. The software architecture of FIG. 5 may be used for the client application described or for the image generating AI engine also described above.

FIG. 5 is a non-limiting example of a software architecture, and it will be appreciated that many other architectures may be implemented to facilitate the functionality described herein. The software architecture 502 may execute on hardware such as client devices, native application provider, web servers, server clusters, external services, and other servers. A representative hardware layer 504 includes a processing unit 506 and associated executable instructions 508. The executable instructions 508 represent executable instructions of the software architecture 502, including implementation of the methods, modules and so forth described herein.

The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular system. The applications 520 may use functions available via OS 514, libraries 516, frameworks 518, and presentation layer 544 to create user interfaces to interact with users.

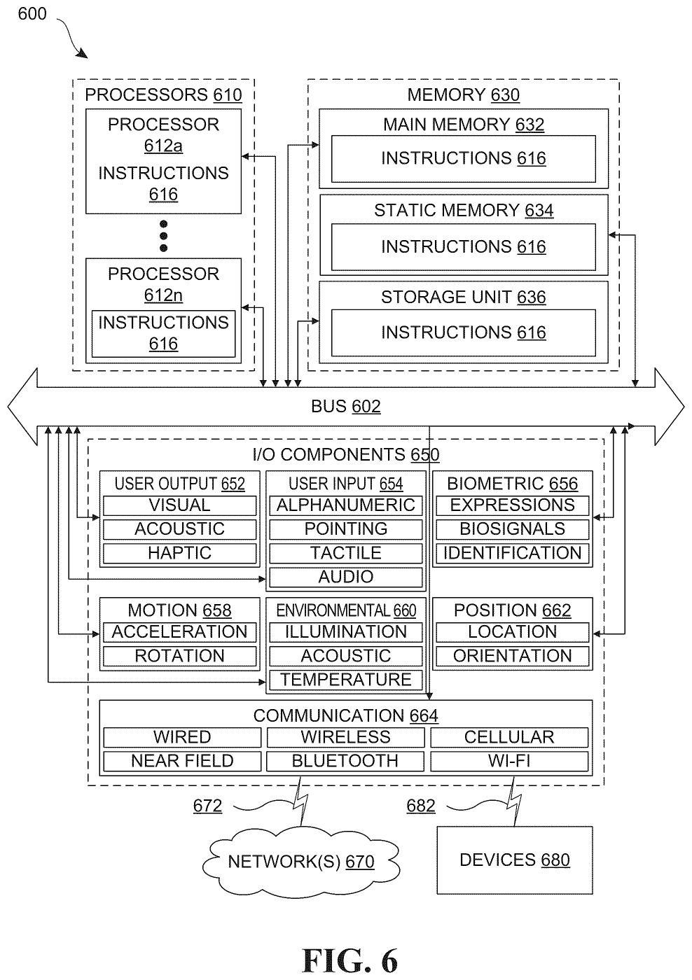

Some software architectures use virtual machines, as illustrated by a virtual machine 548. The virtual machine 548 provides an execution environment where applications/modules can execute as if they were executing on a hardware machine (such as the machine depicted in block diagram 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600. The machine 600 may be used to implement the client device or the server described above.

The machine 600 is configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement methods or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660 and/or position components 662, among a wide array of other environmental sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 662 may include, for example, location sensors (for example, a Global Position System (GPS) receiver), altitude sensors (for example, an air pressure sensor from which altitude may be derived), and/or orientation sensors (for example, magnetometers). The motion components 658 may include, for example, motion sensors such as acceleration and rotation sensors. The environmental components 660 may include, for example, illumination sensors, acoustic sensors and/or temperature sensors.

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:
Item 1. A data processing system comprising;
   a processor;
   a memory comprising instructions for execution by the processor;
   the instructions, when executed by the processor, causing the processor to:
   accept user input from a user, the user input comprising an image;
   tokenize the image to generate a set of tokens for use by an image-generating artificial intelligence engine; and submit the set of tokens to the image-generating artificial intelligence engine to support a request by the user for a customized image corresponding to the tokenized image.
Item 2. The data processing system of Item 1, wherein the instructions further cause the processor to generate a Natural Language Processing (NLP) layer in which terminology that refers to a person or object in the image input by the user is associated with the set of tokens.
Item 3. The data processing system of Item 2, wherein the set of tokens and NLP layer are packaged as a fine-tuning mechanism for submission to the image-generating artificial intelligence engine.
Item 4. The data processing system of Item 3, wherein the fine-tuning mechanism comprises a plug-in or add-in configured for implementation in the image-generating artificial intelligence engine.
Item 5. The data processing system of Item 1, wherein the instructions comprise a client application specific to the image-generating artificial intelligence engine.
Item 6. The data processing system of Item 1, wherein the instructions are incorporated into a browser.
Item 7. A method of generating a customized image with an image-generating artificial intelligence engine, the method comprising:
   generating a fine-tuning mechanism for the image-generating artificial intelligence engine, the fine-tuning mechanism comprising a set of tokens defining an appearance of a person or object to be included in the customized image and a Natural Language Processing (NLP) layer that associates terms for referring to the person or object with the set of tokens; and
   submitting the fine-tuning mechanism to the image-generating artificial intelligence engine.
Item 8. The method of Item 7, wherein the fine-tuning mechanism comprises an add-in or plug-in configured for the image-generating artificial intelligence engine.
Item 9. The method of Item 7, further comprising receiving a set of customization images that depict the person or object and generating the set of tokens from the set of customization images.
Item 10. The method of Item 7, further comprising submitting the fine-tuning mechanism to the image-generating artificial intelligence engine via an Application Programming Interface (API) of the image-generating artificial intelligence engine.
Item 11. The method of Item 7, further comprising generating the NLP layer based on terms used in a textual command entered by a user describing the customized image to be generated.
Item 12. The method of Item 7, further comprising operating a client application specific to the image-generating artificial intelligence engine to generate the fine-tuning mechanism.
Item 13. The method of Item 7, further comprising submitting the fine-tuning mechanism to the image-generating artificial intelligence engine with a textual command entered by a user describing the customized image to be generated.
Item 14. The method of Item 7, further comprising receiving the customized image from the image-generating artificial intelligence engine.
Item 15. A data processing system comprising;
   a server;
   an image-generating artificial intelligence engine on the server; and
   a memory comprising instructions for the image-generating artificial intelligence engine;
   the instructions, when executed by the engine, causing the engine to:
   receive a fine-tuning mechanism that comprises a set of tokens defining an appearance of a specific person or object and a Natural Language Processing (NLP) layer in which terminology that refers to the person or object is associated with the set of tokens; and
generate a personalized image using the set of tokens and NLP layer, the personalized image including a depiction of the specific person or object tokenized in the fine-tuning mechanism.
Item 16. The data processing system of Item 15, wherein the fine-tuning mechanism comprises a plug-in or add-in configured for implementation in the image-generating artificial intelligence engine.
Item 17. The data processing system of Item 15, further comprising an Application Programming Interface of the image-generating artificial intelligence engine to receive and implement the fine-tuning mechanism.
Item 18. The data processing system of Item 15, further comprising a client application on a client device, the client application to receive a customization image from a user and, from the customization image, generate the set of tokens and the fine-tuning mechanism.
Item 19. The data processing system of Item 18, the client application being specific to the image-generating artificial intelligence engine.
Item. The data processing system of Item 18, wherein the client application is to further generate the NLP layer based on a text-to-image instruction entered by a user in connection with the customization image.

In the foregoing detailed description, numerous specific details were set forth by way of examples in order to provide a thorough understanding of the relevant teachings. It will be apparent to persons of ordinary skill, upon reading the description, that various aspects can be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising;
a processor;
a memory comprising instructions for execution by the processor;
the instructions, when executed by the processor, causing the processor to:
accept user input from a user, the user input comprising an image;
tokenize the image to generate a set of tokens for use by an image-generating artificial intelligence engine; and
submit the set of tokens to the image-generating artificial intelligence engine to support a request by the user for a customized image corresponding to the tokenized image.

2. The data processing system of claim 1, wherein the instructions further cause the processor to generate a Natural Language Processing (NLP) layer in which terminology that refers to a person or object in the image input by the user is associated with the set of tokens.

3. The data processing system of claim 2, wherein the set of tokens and NLP layer are packaged as a fine-tuning mechanism for submission to the image-generating artificial intelligence engine.

4. The data processing system of claim 3, wherein the fine-tuning mechanism comprises a plug-in or add-in configured for implementation in the image-generating artificial intelligence engine.

5. The data processing system of claim 1, wherein the instructions comprise a client application specific to the image-generating artificial intelligence engine.

6. The data processing system of claim 1, wherein the instructions are incorporated into a browser.

7. A method of generating a customized image with an image-generating artificial intelligence engine, the method comprising:
generating a fine-tuning mechanism for the image-generating artificial intelligence engine, the fine-tuning mechanism comprising a set of tokens defining an appearance of a person or object to be included in the customized image and a Natural Language Processing (NLP) layer that associates terms for referring to the person or object with the set of tokens; and
submitting the fine-tuning mechanism to the image-generating artificial intelligence engine.

8. The method of claim 7, wherein the fine-tuning mechanism comprises an add-in or plug-in configured for the image-generating artificial intelligence engine.

9. The method of claim 7, further comprising receiving a set of customization images that depict the person or object and generating the set of tokens from the set of customization images.

10. The method of claim 7, further comprising submitting the fine-tuning mechanism to the image-generating artificial intelligence engine via an Application Programming Interface (API) of the image-generating artificial intelligence engine.

11. The method of claim 7, further comprising generating the NLP layer based on terms used in a textual command entered by a user describing the customized image to be generated.

12. The method of claim 7, further comprising operating a client application specific to the image-generating artificial intelligence engine to generate the fine-tuning mechanism.

13. The method of claim 7, further comprising submitting the fine-tuning mechanism to the image-generating artificial intelligence engine with a textual command entered by a user describing the customized image to be generated.

14. The method of claim 7, further comprising receiving the customized image from the image-generating artificial intelligence engine.

15. A data processing system comprising;
a server;
an image-generating artificial intelligence engine on the server; and
a memory comprising instructions for the image-generating artificial intelligence engine;
the instructions, when executed by the engine, causing the engine to:
receive a fine-tuning mechanism that comprises a set of tokens defining an appearance of a specific person or object and a Natural Language Processing (NLP) layer in which terminology that refers to the person or object is associated with the set of tokens; and
generate a personalized image using the set of tokens and NLP layer, the personalized image including a depiction of the specific person or object tokenized in the fine-tuning mechanism.

16. The data processing system of claim 15, wherein the fine-tuning mechanism comprises a plug-in or add-in configured for implementation in the image-generating artificial intelligence engine.

17. The data processing system of claim 15, further comprising an Application Programming Interface of the image-generating artificial intelligence engine to receive and implement the fine-tuning mechanism.

18. The data processing system of claim 15, further comprising a client application on a client device, the client application to receive a customization image from a user and, from the customization image, generate the set of tokens and the fine-tuning mechanism.

19. The data processing system of claim 18, the client application being specific to the image-generating artificial intelligence engine.

20. The data processing system of claim 18, wherein the client application is to further generate the NLP layer based on a text-to-image instruction entered by a user in connection with the customization image.
